(19) United States
(12) Patent Application Publication
(10) Pub. No.: US 2024/0386575 A1
(43) Pub. Date: Nov. 21, 2024

(54) ONE-STAGE PROGRESSIVE DICHOTOMOUS SEGMENTATION

(71) Applicant: SAMSUNG ELECTRONICS CO., LTD., Suwon-si (KR)

(72) Inventors: Jing Zhu, Syosset, NY (US); Karim Ahmed, San Jose, CA (US); Wenbo Li, Santa Clara, CA (US); Yilin Shen, San Jose, CA (US); Hongxia Jin, San Jose, CA (US)

(73) Assignee: SAMSUNG ELECTRONICS CO., LTD., Suwon-si (KR)

(21) Appl. No.: 18/526,875

(22) Filed: Dec. 1, 2023

Related U.S. Application Data
(60) Provisional application No. 63/467,570, filed on May 18, 2023.

(51) Int. Cl. G06T 7/194; G06T 3/40

(52) U.S. Cl. CPC G06T 7/194; G06T 3/40; G06T 2207/20084; G06T 2207/20112

(57) ABSTRACT

Provided is a method and apparatus for obtaining a foreground image from an input image containing the foreground object in a scene. Embodiments use multi-scale convolutional attention values, one or more hamburger heads and one or more multilayer perceptrons to obtain a segmentation map of the input image. In some embodiments, progressive segmentation is applied to obtain the segmentation map.

### CROSS REFERENCE TO RELATED APPLICATION(S)

This application claims benefit of priority to U.S. Provisional Application No. 63/467,570 filed in the USPTO on May 18, 2023. The content of the above application is hereby incorporated by reference.

### FIELD

This application is related to segmenting a foreground object from a scene.

### BACKGROUND

Embodiments are related to dichotomous segmentation. Dichotomous segmentation attempts to recognize foreground objects in high-resolution images with varying characteristics. Existing methods often miss important details of the object or require a long processing time due to using a multi-stage process.

### SUMMARY

Embodiments reduce parameter requirements (reduce memory requirements) and reduce operation counts (reduce computing cost) and reduce delay in producing an accurate segmentation map to separate a foreground object from a scene. Embodiments use a one stage learning model based on an encoder-decoder architecture. The model directly works on high-resolution images without requiring a separate branch for processing low resolution inputs. Since the encoder keeps extracting abstract features from the image while simultaneously reducing the feature map resolution, low-resolution image features are inherently integrated into the encoder. Embodiments include an efficient decoder that gradually uses the multi-scale features from the encoder to generate the final high-resolution segmentation maps. As shown in FIG. 5, embodiments contain two components, an encoder, i.e., feature extractor, and a decoder for progressive prediction. Details of the two components are further discussed below with respect to FIGS. 5-11.

The feature extractor uses attention. Attention mechanism is a kind of adaptive selection process that has proved its effectiveness in a variety of computer vision tasks by enabling the network to focus on significant parts. Although transformers have been increasingly employed as feature extractors due to their impressive learning capabilities from self-attention mechanisms, the high computation complexity of transformers makes it unsuitable for a practical model that operates directly on high-resolution inputs. Consequently, we carefully choose a CNN-based backbone with an effective attention mechanism when designing the feature extractor. The multi-scale convolutional attention module is an effective attention-based module that includes a depth-wise convolution to aggregate local information, multi-branch depth-wise convolutions with different sizes of the receptive fields to capture multi-scale context, and a MLP layer to model relationship between different channels. The output of the MLP layer is used as attention weights directly to reweigh the input of the convolutional attention module. The convolutional attention has shown strong impact on the semantic segmentation task, outperforming transformers with less computational cost. We construct a four-level feature extractor with each level containing multiple multi-scale convolutional attention modules (as depicted at the upper left of FIG. 2) and a convolutional layer to get features with decreasing spatial resolution.

Provided herein is a method of segmenting a foreground object from a scene for image editing or augmented reality, wherein the scene is represented in an input image, the method including obtaining a plurality of feature vectors using a feature extractor, wherein the feature extractor comprises a plurality of multi-scale convolutional attention blocks; and obtaining, based on the plurality of feature vectors and performing an operation using one or more hamburger heads, a prediction image, wherein a first hamburger head of the one or more hamburger heads comprises, in sequence, a first multilayer perceptron (MPL), a matrix decomposition, and a second MLP, wherein the prediction image segments the foreground object from the scene.

Also provided herein is an apparatus comprising: one or more memories; and one or more processors, wherein the one or more processors are configured to execute instructions store in the one or more memories to perform: obtaining a plurality of feature vectors using a feature extractor, wherein the feature extractor comprises a plurality of multi-scale convolutional attention blocks; and obtaining, based on the plurality of feature vectors and performing an operation using one or more hamburger heads, a prediction image, wherein a first hamburger head of the one or more hamburger heads comprises, in sequence, a first multilayer perceptron (MPL), a matrix decomposition, and a second MLP, wherein the prediction image segments the foreground object from a scene for image editing or augmented reality.

Also provided herein is a non-transitory computer readable medium storing instructions to be executed by one or more processors, wherein the instructions are configured to cause the one or more processors to perform: obtaining a plurality of feature vectors using a feature extractor, wherein the feature extractor comprises a plurality of multi-scale convolutional attention blocks; and obtaining, based on the plurality of feature vectors and performing an operation using one or more hamburger heads, a prediction image, wherein a first hamburger head of the one or more hamburger heads comprises, in sequence, a first multilayer perceptron, a matrix decomposition, and a second multilayer perceptron, wherein the prediction image segments a foreground object from a scene for image editing or augmented reality.

### BRIEF DESCRIPTION OF THE DRAWINGS

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of embodiments provided herein.

FIG. 1 illustrates a feature extractor and decoder using a hamburger head,

according to some embodiments.

FIG. 2 illustrates logic for obtaining features using multi-scale convolutional attention blocks, applying a hamburger head and obtaining a prediction image of a foreground object, according to an example embodiment.

FIG. 3 illustrates an example of an input image.

FIG. 4 illustrates an example output image using the apparatus of FIG. 1.

FIG. 5 illustrates an example feature extractor with progressive segmentation, according to an example embodiment.

FIG. 6 illustrates a logic flow for the progressive segmentation of FIG. 5, according to an example embodiment.

FIG. 7 illustrates a predicted segmentation map using the progressive segmentation of FIG. 5, according to an example.

FIG. 8 illustrates an example image of the foreground object using the segmentation map of FIG. 7.

FIG. 9 illustrates an example of the feature extractor.

FIG. 10 illustrates an example of a multi-scale convolutional attention block, according to an example.

FIG. 11 illustrates an example of a signal flow for computing multi-scale convolutional attention.

FIG. 12 illustrates details of a hamburger head, according to an example.

FIG. 13 illustrates the reconstruction operation corresponding to items 24 and 34 of FIG. 5, according to an example.

FIG. 14A illustrates multi-stage segmentation.

FIG. 14B illustrates single stage segmentation.

FIG. 15 illustrates exemplary hardware for implementation of computing devices for implementing the systems and algorithms described by the figures, according to some embodiments.

### DETAILED DESCRIPTION

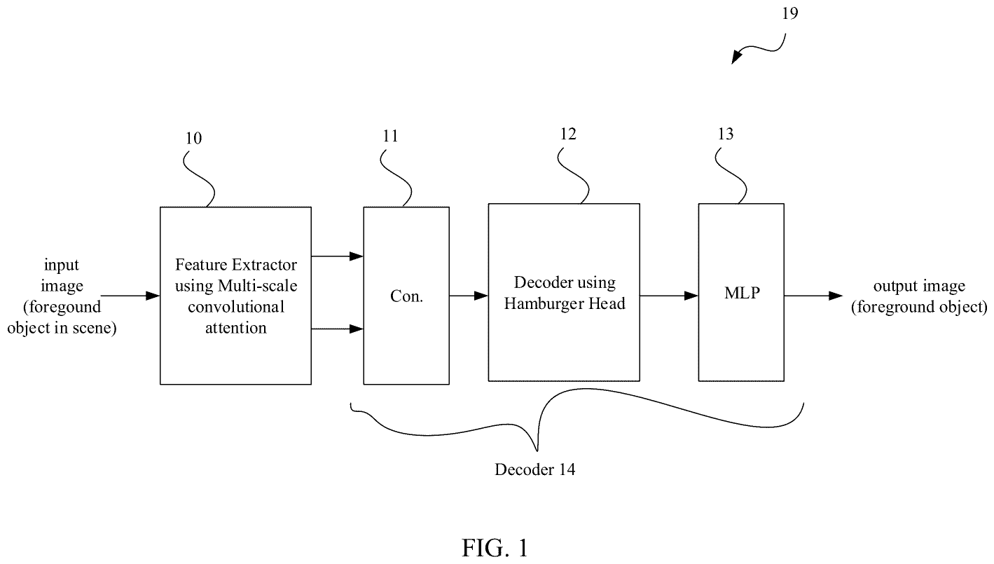

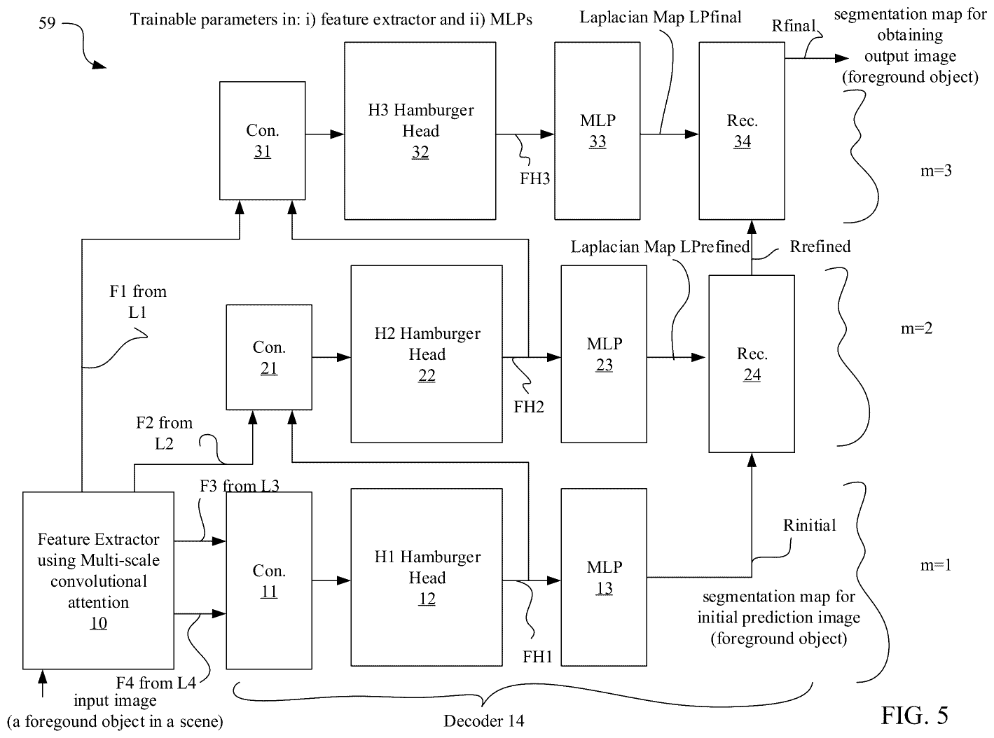

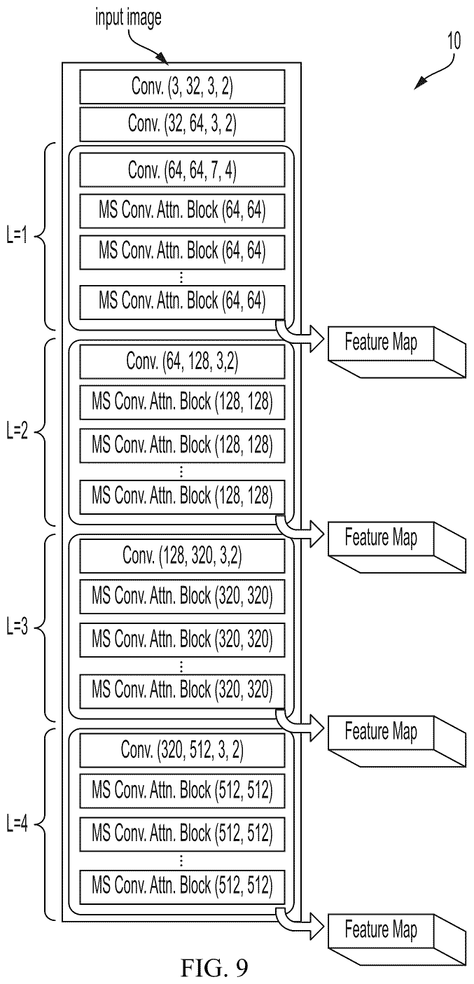

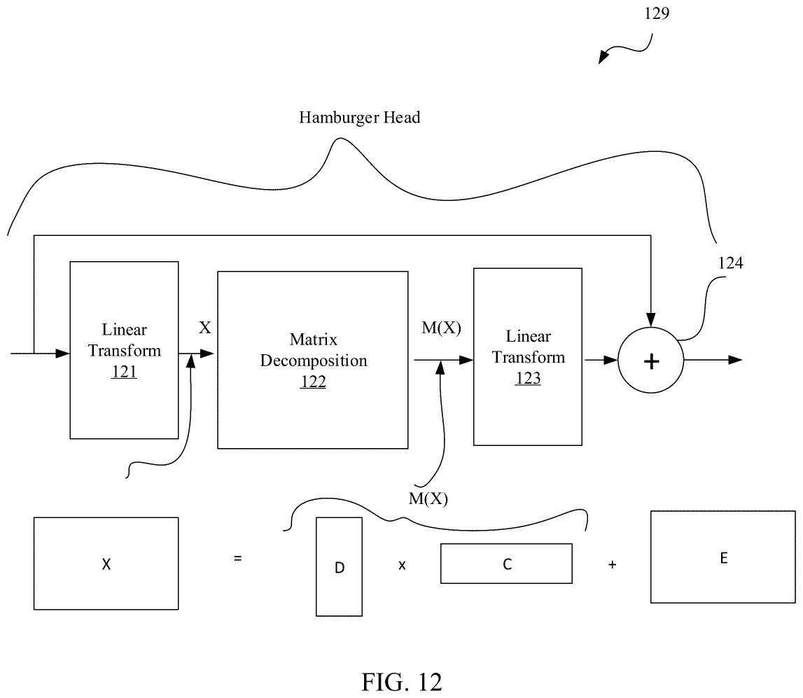

Embodiments use multi-scale features obtained from the feature extractor (FIG. 9), by using a progressive decoder with heads for each scale, which generates an initial prediction using the lowest-level features and then gradually add details from the higher-level features while also increasing the resolution to produce the final prediction. As shown in FIG. 5, the initial prediction is obtained upon the features concatenated by those from level 3 and 4. Embodiments use a hamburger head (FIG. 12) that includes a matrix decomposition between two MLP layers. The hamburger head performance surpasses various decoder heads and the hamburger head only requires O(n) complexity. Let Fᵢ denote the output multiscale features from the i-th level of the feature extractor, let H₁ be the first light hamburger head (item 12 in FIGS. 1 and 5), and let MLP₁ be the MLP layer after the first hamburger head, the initial dichotomous segmentation result (Rᵢₙᵢₜᵢₐₗ, output of item 13 in FIGS. 1 and 5) can be computed as shown in Equation 1.

$${F}_{{H}_{1}} = {H}_{1} ( Concat ( {F}_{3} , {F}_{4} ) ) , {R}_{i n i t i a l} = M L {P}_{1} ( {F}_{{H}_{1}} ) \qquad Equation 1$$

“Concat” is the usual concatenation operation, referred to as “Con.” in the drawings.

As a brief aside, an MLP is composed of multiple layers of interconnected neurons. The structure of an MLP can be broken down into three main parts: the input layer, the hidden layers, and the output layer. When the data is input into MLP, it is first passed through an input layer. In the input layer, there is no specific operation performed but it just transfers the input into the next layer which is the hidden layer. The neurons in the hidden layer perform some operations on the data and then it is passed to the next hidden layer if there is one. Finally, the processed data is passed to the output layer to produce the output. The output of each neuron can be represented with the activation function as: output=ϕ(WX+bias), where ϕ is an activation function such as RELU, Sigmoid, Softmax.

In some embodiments, the initial prediction is obtained as a final output image (representing a segmentation, FIG. 1). Thus, in some embodiments, there is only one hamburger head and the first image is the prediction image (segmentation).

In other embodiments, the initial prediction result is refined by a reconstruction operation together with a Laplacian map generated by another hamburger head (H₂, see FIG. 5 item 22) and a MLP layer (MLP₂) from the concatenated features of F₂ and F_{H}_{₁} (FIG. 5). To address the resolution difference, F_{H}_{₁} is be upsampled with bilinear interpolation before concatenation. The Laplacian map (LP_{refined}) contains high-frequency details.

$${F}_{{H}_{2}} = {H}_{2} ( Concat ( {F}_{2} , {F}_{H} ) ) , L {P}_{refined} = {MLP}_{2} ( {F}_{{H}_{2}} ) \qquad Equation 2$$

In some embodiments, a Laplacian map (see Laplacian Map 1 in FIG. 5) is used to reconstruct (item 24) a refined high-resolution prediction using the initial prediction Rᵢₙᵢₜᵢₐₗwhich needs to be upgraded (upsampled) to achieve the resolution of the Laplacian map LP_{refined} by first filling zeros to the empty space of a larger-size map and then calculating the convolution values with Gaussian weights. The refined result is expressed by Equation 3.

$${R}_{refined} = Upgrade ( {R}_{i n i t i a l} ) + L {P}_{refined} \qquad Equation 3$$

A final prediction can be obtained following a similar process of the refined prediction generation, i.e., Equations 2-3. First, embodiments collect a Laplacian map LP_{final} (see Laplacian Map 2 in FIG. 5) output from the hamburger head (H₃, item 32) giving the concatenation of F₁ and FH₂. Then the refined prediction (R_{refined}) is upgraded, and the values from the Laplacian map and the upgraded refined prediction are summed to yield the final results as shown in Equation 4.

$${F}_{{H}_{3}} = {H}_{3} ( Concat ( {F}_{1} , {F}_{{H}_{2}} ) ) , {LP}_{final} = ML {P}_{3} ( {F}_{{H}_{3}} ) , {R}_{final} = Upgrade ( {R}_{refined} ) + L {P}_{final} \qquad Equation 4$$

Trainable parameters θ are included in the feature extractor (item 10 and the MLPs (items 13, 23 and 33). Embodiments enforce supervision on the multi-scale predictions obtained from different levels. Since the dichotomous segmentation involves only two categories in the segmentation map (for example, 1 for the foreground object, 0 for parts of the scene other than the foreground object), embodiments use a binary cross entropy (BCE) loss for training. The loss function, LOSS, can be formulated as shown in Equation 5.

$$LOSS ( θ ) = {λ}_{1} BCE ( θ , {R}_{i n i t i a l} , G ) + {λ}_{2} BCE ( θ , {R}_{refined} , G ) + {λ}_{3} BCE ( θ , {R}_{final} , G ) , θ = argmin ( LOSS ( θ ) ) \qquad Equation 5$$

The parameters λ₁, λ₂, and λ₃ are weighting hyperparameters, θ is the set of trainable parameters in the feature extractor and MLPs, and G is the ground truth dichotomous segmentation map.

Embodiments will now be described with respect to the drawings.

FIG. 1 illustrates a block diagram for performing single stage dichotomous segmentation.

An input image showing a foreground object in a scheme is input to a feature extractor using multi-scale convolutional attention (item 10). Features from the feature extractor are input to a concatenation function 11 and the concatenated feature vectors are input to a decoder 14 using a hamburger head (item 12). Details of a hamburger head are shown in FIG. 12. The output of the hamburger head is input to a multi-layer perceptron 13 (also referred to as an MLP layer). The output of the MLP 13 is an output image showing a segmentation map.

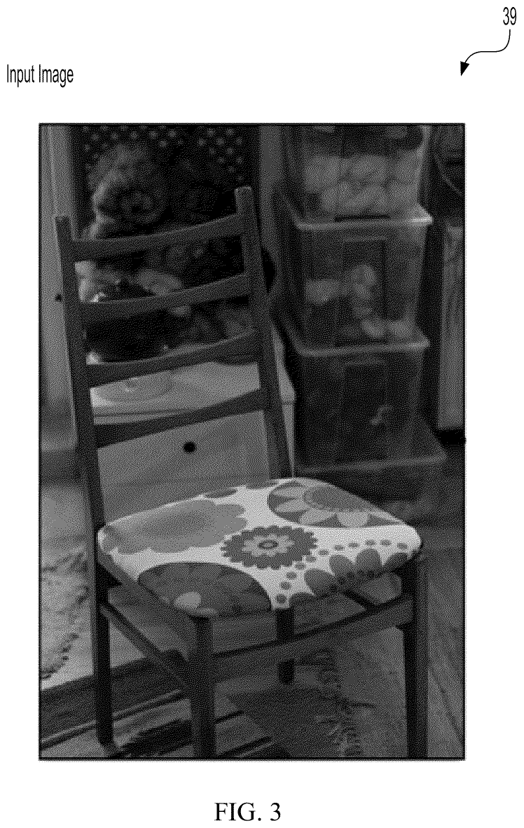

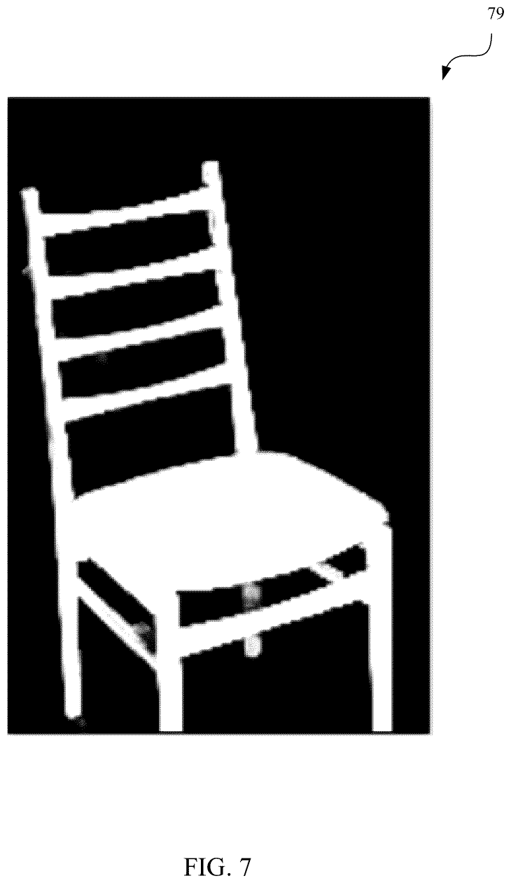

The output image of the foreground object is obtained by performing a logical AND operation between the input image (for example, FIG. 3) and the output segmentation map (for example, FIG. 7).

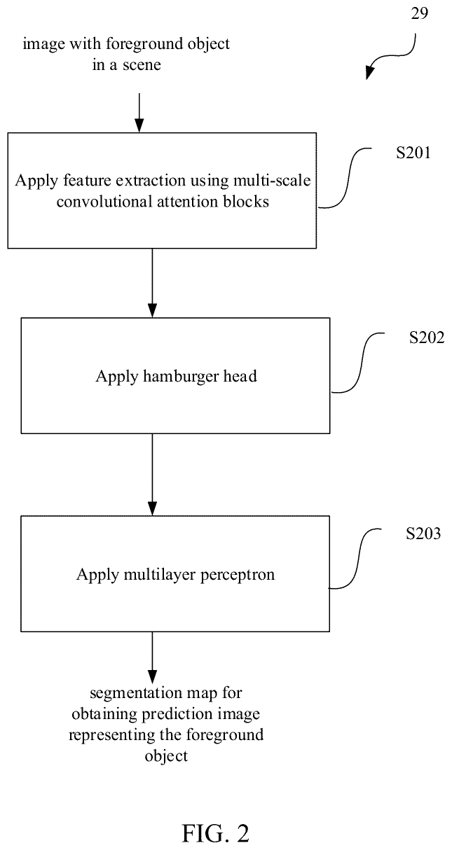

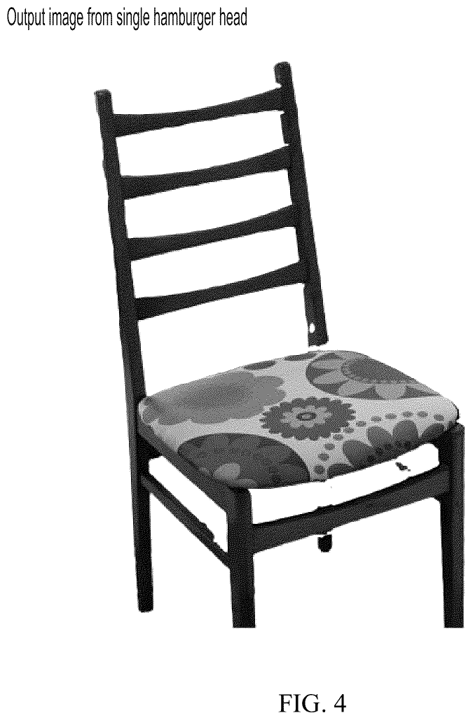

FIG. 2 illustrates logic 29 for obtaining a segmentation map. Operation S201 receives an image with a foreground object in a scene and applies a feature extraction using multi-scale convolutional attention blocks. An example of an input image 39 is shown in FIG. 3. At operation S202, a hamburger head is applied to some of the features from the feature extraction. At operation S203, a multilayer perceptron (MLP) is applied to the output of the hamburger head. The output of the MLP is a prediction image Rᵢₙᵢₜᵢₐₗ showing a segmentation (for example, FIG. 4 and see Equation 1). In some embodiments, the output of S203 is the final output. In some other embodiments (for example, FIG. 5) the output of S203, Rᵢₙᵢₜᵢₐₗ, is an intermediate result in a process of progressive segmentation.

FIG. 5 illustrates progressive segmentation to obtain a prediction image showing a segmentation.

In FIG. 5, the feature extractor 10 obtains feature F₁ at level L1, feature F₂ at level L2, feature F₃ at level L3 and feature F₄ at level L4. The feature from each level may also be referred to as a feature vector. Features F₃ and F₄ are processed by concatenation 11 and the result passes through hamburger head 12. The output of hamburger head 12, F_{H}_{₂}, is input to both concatenation 21 and MLP 13. The output of MLP 13 is Rᵢₙᵢₜᵢₐₗ (see Equation 1). The concatenation 11, hamburger head 12 and MLP 13 are associated with a scale index of m =1. Scale index of m=1 corresponds to coarse features.

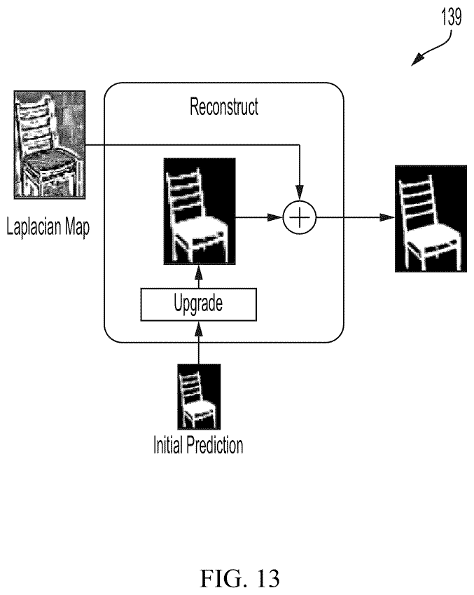

The progressive segmentation continues at concatenation 21, hamburger head 22, MLP 23 and reconstruction 24; taken together these correspond to a scale index of m=2. Features F₂ are concatenated with F_{H}_{₁} output from hamburger head 12 and the result is input to hamburger head 22. The output of hamburger head 22, F_{H}_{₂}, is input to concatenation 31 and input to MLP 23. The output of MLP 23 is a Laplacian map LP_{refined} (see Equation 2). Reconstruction 24 operates on LP_{refined} and Rᵢₙᵢₜᵢₐₗ to provide R_{refined} (see Equation 3 and FIG. 13).

In this embodiment, progressive segmentation continues yet further at concatenation 31, hamburger head 32, MLP 33 and reconstruction 34. These correspond to a scale index of m=3. Features F₁ and F_{H}_{₂} are concatenated and input to hamburger head 32. The result, F_{H}_{₃} is input to MLP 33. Reconstruction 34 operates on the output of MLP 33 and on R_{refined} to produce the final predicted segmentation, R_{final} (also see Equation 4). An example of R_{final} is shown in FIG. 7.

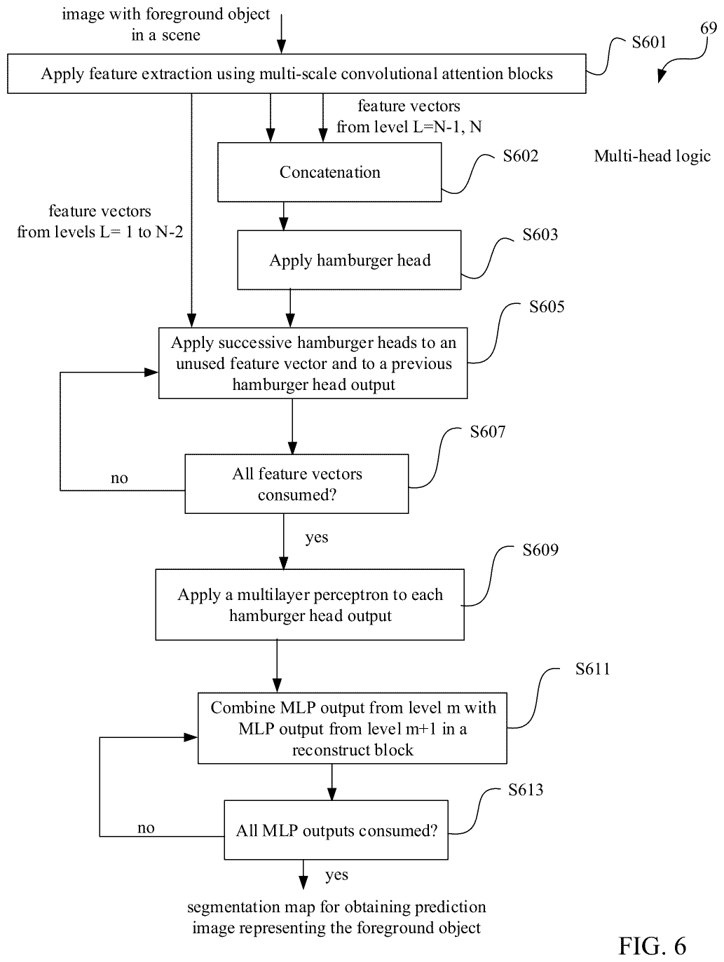

FIG. 6 illustrates exemplary logic 69 for obtaining R_{final}.

Operation S601 applies feature extraction using multi-scale convolutional attention blocks to an image with a foreground object in a scene. The feature extractor outputs feature vectors F1, . . . , FN, from levels L1, . . . , LN.

At operation S602, the feature vectors from the highest two levels are concatenated. The concatenated result is then processed by a hamburger head (operation S603). An MLP is applied to obtain an initial segmentation map (operation S609 in FIG. 6). Thus, embodiments include applying the first hamburger head to a third feature vector and a fourth feature vector to obtain a first intermediate vector when the number of levels is four, and applying a first multilayer perceptron to the first intermediate vector to obtain a first image (segmentation).

At operation S605, a hamburger head is applied to a concatenation of an unused feature vector (proceeding downward a level) and the output of the hamburger head of operation S603. An MLP is applied to obtain a refined segmentation map as a Laplacian map (operation S609 in FIG. 6). Thus, embodiments include applying a second hamburger head to the second feature vector and the first intermediate vector to obtain a second intermediate vector (when the number of levels is four). Applying an MLP to obtain LP_{refined} is an example of applying a second multilayer perceptron to the second intermediate vector to obtain a first image map.

Progressive segmentation is achieved by concatenating an unused feature vector with a most-recently produced hamburger head and MLP output and applying another hamburger head and MLP at operation S605 until operation S607 indicates all feature vectors have been consumed. This progressive segmentation corresponds to the signal flow working upward in FIG. 5 from scale index m=1 to scale index m=2 and so on upwards. Also, each hamburger head output has been used to obtain a segmentation map (operation S609). When there are four levels, the last step in the progressive segmentation is to apply a third multilayer perceptron to the third intermediate vector to obtain a second image map (LP_{final}).

The MLP outputs are then consumed at operations S611 and S613 using respective reconstruction blocks. Details of a reconstruction block are shown in FIG. 13. This corresponds to working from bottom to top in the right portion of FIG. 5. For four levels, embodiments include performing a first reconstruction using the initial prediction image and the first image map to obtain a refined prediction image (R_{refined}) and performing a second reconstruction using the refined prediction image and the second image map to obtain the final prediction image (segmentation, R_{final}).

The output of the final reconstruction is the final segmentation map (see FIG. 7

for an example).

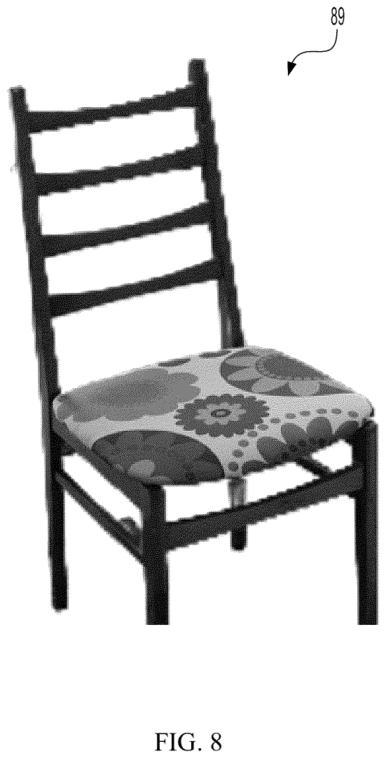

FIG. 8 is an example of an image representing the recovered foreground object.

FIG. 9 illustrates details of the feature extractor 10. In an example embodiment, the feature extractor includes, at its input, a convolutional layer with dimensions (3,32,3,2) and a convolutional layer with dimensions (32,64,3,2). This 4-tuple is input channel size, output channel size, kernel size and stride.

In the example of FIG. 9, there are four convolutional attention modules, one for each level.

The feature extractor consists of two convolutional layers followed by four levels of multi-scale convolutional attention modules. Each level contains a convolutional layer and multiple multi-scale convolutional attention blocks. Thus, the feature extractor comprises a convolutional layer and a plurality of multi-scale convolutional attention modules. The convolutional layer reduces the resolution of the feature map, while the multi-scale convolutional attention blocks maintain the same size as the input feature map. This process results in feature maps of varying resolutions from the four levels (L=1, 2, 3, 4). These feature maps are subsequently utilized by the progressive decoder 14 to generate a segmentation map. Thus, the plurality of feature vectors comprises obtaining the plurality of feature vectors corresponding to the plurality of multi-scale convolutional attention blocks.

The numbers in each multi-scale convolutional attention block (a 2-tuple) are the input channel and output channel size.

For L=1, the 4-tuple at the input of input channel size, output channel size, kernel size and stride is (64,64,7,4). The 2-tuple of input channel size and output channel size is (64,64), the output feature map (also called a feature vector) is F₁.

For L=2, the 4-tuple is (64, 128,3,2). The 2-tuple is (128,128). The output feature vector is F2.

For L=3, the 4-tuple is (128,320,3,2). The 2-tuple is (320,320). The output feature vector is F3.

For L=4, the 4-tuple is (320,512,3,2). The 2-tuple is (512,512). The output feature vector is F4.

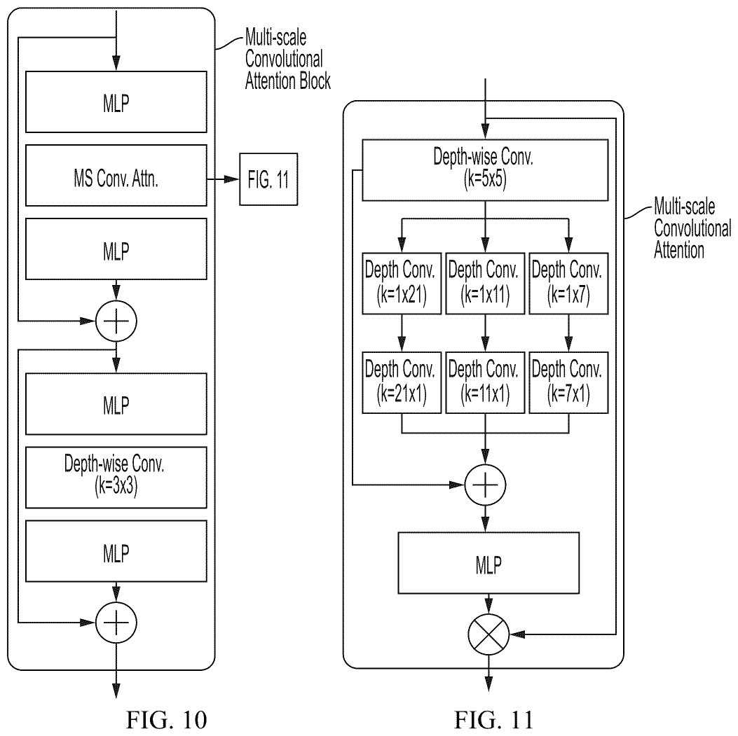

FIG. 10 illustrates a multi-scale convolutional attention block. Each multi-scale convolutional attention block consists of a multi-scale convolutional attention (FIG. 11), several MLPs, and a depth-wise convolutional layer. The input features of the block are combined with the features weighted by attention using element wise addition (⊕), which are calculated by the multi-scale convolutional attention (FIG. 11). The resulting feature is then passed through two MLP layers and a depth-wise convolutional layer to enhance its representations.

Standard convolution is computed at all channels with k*k*m filter (in this convolution explanation, m is the channel size), while depth-wise convolution calculates the values channel by channel with m separate k*k filters. The output of a standard convolution is a single value for each k*k*m area in the feature map, while the output of a depth-wise convolution for k*k*m area has m values.

Given wᵢ as the weight in the k*k filter, the output equals Σᵢwᵢxᵢ+b, where xᵢ is the value of the input within a sliding window.

FIG. 11 illustrates the signal flow of the multi-scale convolutional attention. The attention values are found using depth-wise convolution to obtain multi-scale attentions and an MLP to integrate these attentions. The integrated attention is used to reweight the inputs through an element-wise multiplication (⊗) operation, where area of significance will have higher weights.

FIG. 12 illustrates details of an example hamburger head 129.

Each hamburger head includes a first linear transform, a matrix decomposition operation, and another linear transform. The linear transform may be the application of a matrix to the data vector input to the hamburger head. The matrix decomposition operation filters out redundancy and incompleteness in the given input, allowing the reconstruction of the core content.

Referring to FIG. 12, the input signal is processed by a linear transform 121, followed by a matrix decomposition 122 and further followed by a linear transform 123. The input is then element-wise added by summer 124 to the output of the linear transform 123 to produce the output of the hamburger head 129.

The matrix decomposition of the hamburger head decomposes an input X into an outer product of a column vector D and a row vector C (resulting in M(X)), the product M(X) being summed with a matrix E. The matrix E is discarded and M(X) is passed into the linear transform 123.

FIG. 13 illustrates operation of an example reconstruction block 139. A lower resolution segmentation prediction map is reconstructed into a higher resolution one using a higher-resolution Laplacian map. The lower-resolution segmentation prediction map is first upgraded (upsampled) to match the resolution of the Laplacian map by filling zeros in the empty space of a larger-size map and then calculating the convolution values with Gaussian weights. The higher-resolution prediction is obtained by summing up the upgraded (upsampled) segmentation map and the Laplacian map. Thus, embodiments include performing a first reconstruction using the initial prediction image (Rᵢₙᵢₜᵢₐₗ) and the first image map (LP_{refined}) to obtain a refined prediction image, performing a second reconstruction using the refined prediction image (R_{refined}) and the second image map to obtain the final prediction image (R_{final}). In some embodiments, the second image map is a Laplacian map (LP_{final}), and the performing the second reconstruction includes upsampling the refined prediction image to obtain an upsampled image; and summing the Laplacian map with the upsampled image (see FIG. 13) to obtain the final prediction image.

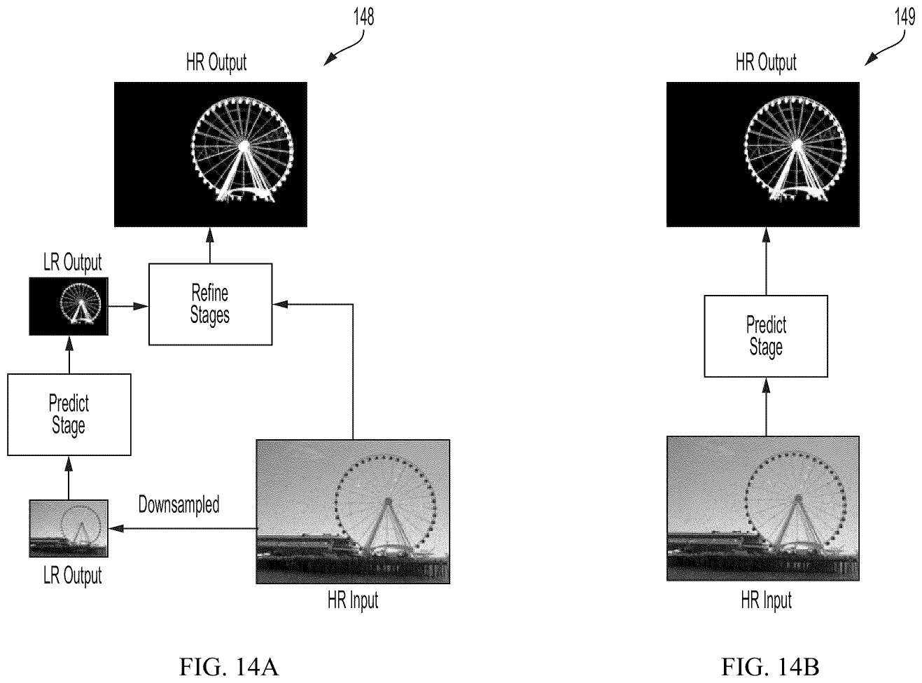

FIGS. 14A and 14B contrast a multi-stage approach to segmentation with a single stage approach to segmentation.

Dichotomous segmentation is a significant problem in the field of computer vision. Current existing methods can be classified into two categories: (a) multi-stage methods that generate coarse results from low-resolution images and refine them with high-resolution images to obtain high-resolution predictions, and (b) one-stage methods that directly operate on high-resolution images to produce high-resolution predictions without relying on low-resolution images as auxiliary.

Multi-stage methods (item 148, FIG. 14A) have the potential to generate superior results, but they often come with time and memory expenses. In contrast, one-stage methods (FIG. 14B item 149) offer a more straightforward approach with lower computation costs. However, they typically yield inferior performance because many effective high-complexity networks (e.g., transformer), cannot directly handle high-resolution images due to resource limit. Embodiments provided herein provide good performance with a one-stage method.

Embodiments significantly outperform all the single-stage methods including the dichotomous segmentation method IS-Net. Furthermore, embodiments handle high-resolution inputs with fewer model parameters and less computational operations. Multistage models generally require more time for prediction.

As a quantitative example, a reference multi-stage method uses 90.7 million parameters, requires 733 ms to perform, consumes 461 GFLOPs on an input size of 1024×1024. The Fmx output is 0.854 on an example data set.

Embodiments provided herein (FIG. 5), uses 28.0 million parameters, requires 287 ms to perform, consumes 129 GFLOPs on an input size of 1024×1024. The Fmx output is 0.822 on the example data set.

Thus embodiments uses about 69% fewer parameters (θ), executes in about 61% less time and produces substantially similar quality to a benchmark multi-stage approach.

This improvement in computing performance is achieved using a one-stage framework with an efficient yet effective multi-scale convolutional attention feature extractor (FIG. 5 item 5), enabling direct processing of high-resolution images for dichotomous segmentation. Also contributing to the improvement is a progressive decoder with progressive prediction, which generates an initial segmentation map using the lowest-resolution features and progressively refine map's resolution level by level (see m=1, 2, 3 in FIG. 5), based on the extracted multi-scale features from the feature extractor.

Regarding explanation of the performance measure, in statistical analysis of binary classification, the F-score or F-measure is a measure of a test's accuracy. It is calculated from the precision and recall of the test, where the precision is the number of true positive results divided by the number of all positive results, including those not identified correctly, and the recall is the number of true positive results divided by the number of all samples that should have been identified as positive. Precision is also known as positive predictive value, and recall is also known as sensitivity in diagnostic binary classification.

The F1 score is the harmonic mean of the precision and recall. It thus symmetrically represents both precision and recall in one metric.

Fmx represents maximal F-measure based on Equation 6 (β is a value chosen to weight precision more than recall). Fmx is obtained using β²=0.3 in Equation 6.

$${F}_{β} = \frac{( 1 + {β}^{2} ) Precision \cdot Recall}{{β}^{2} \cdot Precision + Recall} \qquad Equation 6$$

The highest possible value of an F-score is 1.0, indicating perfect precision and recall, and the lowest possible value is 0, if either precision or recall are zero.

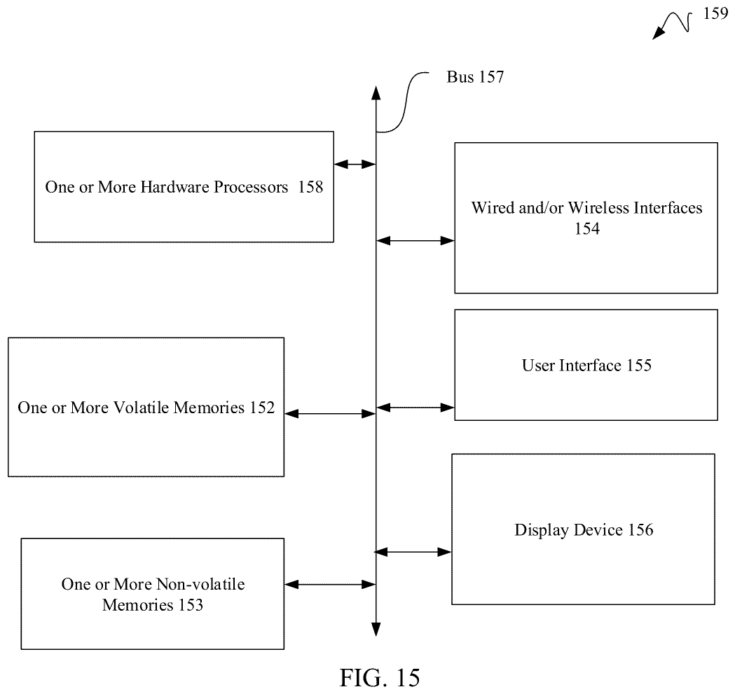

Hardware for performing embodiments provided herein is now described with respect to FIG. 15. FIG. 15 illustrates an exemplary apparatus 159 for implementation of the embodiments disclosed herein. The apparatus 159 may be a server, a computer, a laptop computer, a handheld device, or a tablet computer device, for example. Apparatus 159 may include one or more hardware processors 158. The one or more hardware processors 158 may include an ASIC (application specific integrated circuit), CPU (for example CISC or RISC device), and/or custom hardware. Embodiments can be deployed on various GPUs.

Embodiments may be deployed on various computers, servers or workstations.

Apparatus 159 also may include a user interface 155 (for example a display screen and/or keyboard and/or pointing device such as a mouse). Apparatus 159 may include one or more volatile memories 152 and one or more non-volatile memories 153. The one or more non-volatile memories 153 may include a non-transitory computer readable medium storing instructions for execution by the one or more hardware processors 158 to cause apparatus 159 to perform any of the methods of embodiments disclosed herein.

What is claimed is:

1. A method of segmenting a foreground object from a scene for image editing or augmented reality, wherein the scene is represented in an input image, the method comprising:
obtaining a plurality of feature vectors using a feature extractor, wherein the feature extractor comprises a plurality of multi-scale convolutional attention blocks; and
obtaining, based on the plurality of feature vectors and performing an operation using one or more hamburger heads, a prediction image, wherein a first hamburger head of the one or more hamburger heads comprises, in sequence, a first multilayer perceptron (MPL), a matrix decomposition, and a second MLP,
wherein the prediction image segments the foreground object from the scene.

2. The method of claim 1, wherein the feature extractor comprises a convolutional layer and a plurality of multi-scale convolutional attention modules.

3. The method of claim 2, wherein the obtaining the plurality of feature vectors comprises obtaining the plurality of feature vectors corresponding to the plurality of multi-scale convolutional attention blocks.

4. The method of claim 3, wherein the prediction image is a final prediction image.

5. The method of claim 4,
wherein the plurality of feature vectors comprises a first feature vector, a second feature vector, a third feature vector and a fourth feature vector,
the method further comprising:
applying the first hamburger head to the third feature vector and the fourth feature vector to obtain a first intermediate vector;
applying a first multilayer perceptron to the first intermediate vector to obtain a first image.

6. The method of claim 5, wherein the first image is an initial prediction image.

7. The method of claim 6, further comprising applying a second hamburger head to the second feature vector and the first intermediate vector to obtain a second intermediate vector.

8. The method of claim 7, further comprising applying a second multilayer perceptron to the second intermediate vector to obtain a first image map.

9. The method of claim 8, further comprising applying a third hamburger head to the first feature vector and the second intermediate vector to obtain a third intermediate vector.

10. The method of claim 9, further comprising applying a third multilayer perceptron to the third intermediate vector to obtain a second image map.

11. The method of claim 10, further comprising performing a first reconstruction using the initial prediction image and the first image map to obtain a refined prediction image.

12. The method of claim 11, further comprising performing a second reconstruction using the refined prediction image and the second image map to obtain the final prediction image.

13. The method of claim 12, wherein the second image map is a Laplacian map, and the performing the second reconstruction comprises:
upsampling the refined prediction image to obtain an upsampled image; and
summing the Laplacian map with the upsampled image to obtain the final prediction image.

14. The method of claim 5, wherein the one or more hamburger heads is only one hamburger head and the first image is the prediction image.

15. The method of claim 14, wherein the performing the operation comprises in sequence a first linear transforming, a matrix decomposing, and a second linear transforming.

16. The method of claim 15, wherein the matrix decomposing comprises decomposition into a product and a summand.

17. The method of claim 16, wherein the matrix decomposing further comprises discarding the summand, so that a noise is reduced in the final prediction image.

18. The method of claim 10, wherein the feature extractor, the one or more hamburger heads, the first multilayer perceptron, the second multilayer perceptron and the third multilayer perceptron are comprised in an artificial intelligence machine and the artificial intelligence machine is trained by:
forming a first loss term based on the initial prediction image;
forming a second loss term based on a refined prediction image;
forming a third loss term based on the final prediction image; and
updating weights of the artificial intelligence machine based on a weighted sum of the first loss term, the second loss term and the third loss term.

19. An apparatus comprising:
one or more memories; and
one or more processors, wherein the one or more processors are configured to execute instructions store in the one or more memories to perform:
obtaining a plurality of feature vectors using a feature extractor, wherein the feature extractor comprises a plurality of multi-scale convolutional attention blocks; and
obtaining, based on the plurality of feature vectors and performing an operation using one or more hamburger heads, a prediction image, wherein a first hamburger head of the one or more hamburger heads comprises, in sequence, a first multilayer perceptron (MPL), a matrix decomposition, and a second MLP,
wherein the prediction image segments the foreground object from a scene for image editing or augmented reality.

20. A non-transitory computer readable medium storing instructions to be executed by one or more processors, wherein the instructions are configured to cause the one or more processors to perform:
obtaining a plurality of feature vectors using a feature extractor, wherein the feature extractor comprises a plurality of multi-scale convolutional attention blocks; and
obtaining, based on the plurality of feature vectors and performing an operation using one or more hamburger heads, a prediction image, wherein a first hamburger head of the one or more hamburger heads comprises, in sequence, a first multilayer perceptron, a matrix decomposition, and a second multilayer perceptron,
wherein the prediction image segments a foreground object from a scene for image editing or augmented reality.
